(19) United States
(12) Patent Application Publication
(10) Pub. No.: US 2026/0309885 A1
(43) Pub. Date: Oct. 8, 2026

(54) A Method of Predicting Hydrocarbon Reservoir Properties in a Three Dimensional Model of a Seismic Volume

(71) Applicant: iRPM Pty Ltd, Kelmscott (AU)

(72) Inventor: Wesley Joseph Emery, Kelmscott (AU)

(73) Assignee: iRPM Pty Ltd, Kelmscott (AU)

(21) Appl. No.: 19/481,001

(22) PCT Filed: May 2, 2024
(86) PCT No.: PCT/AU2024/050426

§ 371 Date: Nov. 3, 2025

(30) Foreign Application Priority Data
May 2, 2023 (AU) 2023901304

(51) Int. Cl. G01V 1/50

(52) U.S. Cl. CPC G01V 1/50; G01V 2210/614; G01V 2210/6169; G01V 2210/6244; G01V 2210/6246; G01V 2210/667

(57) ABSTRACT

A method and system of predicting hydrocarbon reservoir properties in a three dimensional model of a seismic volume. This includes determining three dimensional seismic inversion property volumes from seismic data, determining relationships between the three dimensional seismic inversion property volumes and well-log data, determining predicted petrophysical properties based on the relationships between the three dimensional seismic inversion property volumes and well-log data and adapting the predicted petrophysical properties to a three dimensional static and/or dynamic model based on the three dimensional seismic inversion property volume.

### TECHNICAL FIELD

The present invention relates to a method of predicting hydrocarbon or fluid filled reservoir properties in a three dimensional model of a seismic volume.

### BACKGROUND

Any references to methods, apparatus or documents of the prior art are not to be taken as constituting any evidence or admission that they formed, or form part of the common general knowledge.

The Oil and Gas industry typically utilises well log averages to conceptually populate a three dimensional static and/or dynamic model but in more recent times has also used probabilistic and stochastic predictions to determine the likely occurrence of reservoir properties based on averages of input data which introduces inaccuracies and biases.

An example of a conceptual approach is a geological conceptual based model that represents geological knowledge often visualised by 2D geologic cross-sections. An example of a probabilistic approach is a stochastic model based around the average oil/gas well properties.

Conceptual and statistical based methods take considerable time to yield useful results (often 6 months or many years) requiring extensive “co-kriging” or constraining of related variables/properties and such methods are largely inaccurate and are rarely ever validated by blind testing.

The use of log averages are unable to predict the precise rock property and cannot predict the variation in reservoir quality.

These existing approaches are slow, inaccurate and are often infected with heuristic cognitive biases imparted by human operators, interpretations and preconceived conceptual biases.

A significant problem with existing systems and methods is that the use of averages at the well and statistics constrained to the seismic properties at the well to predict properties away from the well, only facilitates the prediction of the average or most common properties without offering predictions on best and/or worst properties of the well.

For example, in United States Patent Publication No. US 2019/0025461, fracture prediction and water saturation prediction are performed using log resistivity data. The document discloses the use of averages for various properties, which reduces the prediction accuracy of the precise value and only predicts the “average” value. There may be low uncertainty on the average value but it cannot (and never will) predict the variation in the properties. In addition, the log resistivity is not available in the three dimensional Seismic volume and therefore cannot be used as a reference or constraining independent property and thus only a stochastic property prediction can be used based upon averages

Most existing systems and processes use upscaling or blocking of the log data (typically at 0.5 ft sampling) which is essentially averaging to the resolution of the Seismic or gridding (typically at 1, 2, 4 m). This averaging reduces the capability to predict the high and low extremities of the property sampled, thus the variability.

### SUMMARY OF INVENTION

In an aspect, the invention provides a method of predicting hydrocarbon reservoir properties in a three dimensional model of a seismic volume, the method includes:
determining three dimensional seismic inversion property volumes from seismic data;
determining relationships between the three dimensional seismic inversion property volumes and well-log data;
determining predicted petrophysical properties based on the relationships between the three dimensional seismic inversion property volumes and well-log data; and
adapting the predicted petrophysical properties to a three dimensional static and/or dynamic model based on the three dimensional seismic inversion property volumes.

Preferably, the three dimensional seismic inversion property volumes is determined by applying seismic inversion to the seismic data. More preferably, the seismic invention is applied to the entirety of the seismic data.

Preferably, the method further includes generating a visual representation of the three dimensional static and/or dynamic model.

Preferably, the three dimensional seismic inversion property volumes comprise log acoustic variables. Preferably, the three dimensional seismic inversion property volumes comprises seismic attributes including one or more of Acoustic Impedance (AI), Elastic Impedance at specific angles (EI), Extended Elastic Impedance (EEI), Compressional Velocity Shear Velocity Ratio (VPVS), Density (DENS/RHOB), and Lambda-Rho.

Preferably, the well-log data includes data relating to one or more of gamma ray, spontaneous potential, deep, medium and shallow resistivity, density, neutron, compressional sonic, shear sonic and photoelectric effect.

Preferably, the petrophysical properties include one or more of volume of clay/shale, reservoir quality, total and effective porosity, permeability, total and effective water saturation initially in-place and residual water saturation. More preferably, the petrophysical properties include one or more of volume of clay, porosity, permeability and water saturation.

Preferably, adapting the predicted petrophysical properties to a three dimensional static and/or dynamic model based on the three dimensional seismic inversion property volumes includes adapting the predicted petrophysical properties to a three dimensional static and/or dynamic model based on three dimensional seismic inversion property volumes. More preferably, adapting the petrophysical properties to the three dimensional static and/or dynamic model based on the three dimensional seismic inversion property volumes includes adapting the petrophysical properties from seismic attributes of the well-log data to corresponding seismic attributes of the three dimensional seismic inversion property volumes in a two-way time domain or depth domain using a conversion function and based on a seismic resolution of the well-log data or seismic data and sampling of the seismic data in three dimensions.

Preferably, the method further includes receiving or generating seismic data from data obtained from seismic surveys or seismic traces (seismograms) conducted in relation to the seismic volume.

Preferably, determining relationships between the three dimensional seismic inversion property volumes and well-log data does not include log averages or log average data. Additionally, or alternatively, determining predicted petrophysical properties based on the relationships between the three dimensional seismic inversion property volumes and well-log data does not include log averages or log average data.

Preferably, the method includes applying the predicted petrophysical properties to a non-calibrated or blind tested well data and determining accuracy of the predicted petrophysical properties within the three dimensional static and/or dynamic model.

Preferably, determining relationships between the three dimensional seismic inversion property volumes and well-log data includes determining relationships between seismic attributes of the three dimensional seismic inversion property volumes and corresponding seismic attributes of the well-log data.

Preferably, the method further includes determining in-place and/or residual hydrocarbon volumes in the seismic volume from the model.

In another aspect, the invention provides a system for predicting hydrocarbon reservoir properties in a three dimensional model of a seismic volume, the system comprising:
a memory storing instructions for one or more procedures; and
a processing assembly configured to execute the one or more procedures stored in the memory;
wherein the one or more procedures, when executed by the processing assembly cause acts to be performed including:
   determining three dimensional seismic inversion property volumes from seismic data;
   determining relationships between the three dimensional seismic inversion property volumes and well-log data;
   determining predicted petrophysical properties of the seismic volume based on the relationships between the three dimensional seismic inversion property volumes and well-log data; and
   adapting the predicted petrophysical properties to a three dimensional static and/or dynamic model based on the seismic impedance volume.

In another aspect, the invention provides a method of predicting hydrocarbon reservoir properties in a three dimensional model of a seismic volume, the method includes:
determining seismic impedance volume from seismic data;
determining relationships between the seismic impedance volume and well-log data;
determining predicted petrophysical properties based on the relationships between the seismic impedance volume and well-log data; and
adapting the predicted petrophysical properties to a three dimensional static model based on the seismic impedance volume.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a cross-sectional illustrate of an example of a well;

FIG. 2 illustrates a block diagram of computer system configured to predict the properties of the seismic volume and carry out the method;

FIG. 3 is a flowchart of a method for predicting hydrocarbon reservoir properties in a three dimensional model of a seismic volume;

FIG. 4 illustrates well calibration;

FIG. 5 illustrates an output of a three dimensional model from the method;

FIG. 6 illustrates examples of three dimensional property modelling;

FIG. 7 illustrates examples of four dimensional (including time) property modelling;

FIG. 8 illustrates examples of three dimensional property modelling uncertainty;

FIG. 9 illustrates a density-neutron cross-plot in the logarithmic domain; and

FIG. 10 illustrates an AI-VPVS cross-plot in the logarithmic and seismic domains.

### DETAILED DESCRIPTION OF PREFERRED EMBODIMENTS

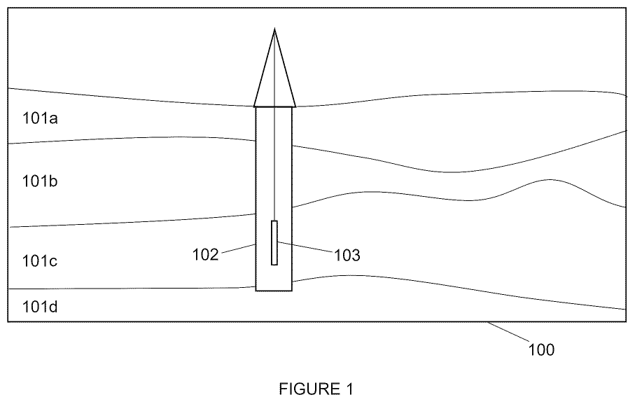

FIGS. 1 to 3 illustrates methods and systems for predicting hydrocarbon (i.e. oil and/or gas) reservoir properties in a three dimensional model of a subsurface seismic volume.

Accurately estimating production rates in hydrocarbon development is crucial for determining the value and feasibility of a project, as well as deciding the number and location of wells. However, the high cost of development means that acquiring accurate information in a cost-effective and time-efficient manner is essential.

Embodiments of the the present disclosure provide more accurate and granular predicted properties based on relationships identified between seismic attributes and petrophysical properties between wells.

In one embodiment, the invention provides developing relationships between log acoustic variable (such as Density-RHOB, Compressional Sonic-DTC and Shear Sonic-DTS, for example) and standard petrophysical properties (such as Vclay—including several clay types—, total and effective porosity, total and effective water saturation, silty shaly sand lithologies, calcite cements, volcanics, reservoir quality, permeability, initial in-place water saturation and residual/flushed imbibed water saturation to determine ultimate recoverable volumes.

These relationship may be adjusted to suit the same properties available in the seismic domain (namely, Acoustic Impedance (RHOB/DTC), VpVs (DTC/DTS), Shear Impedance (RHOB/DTC), Elastic Impedance and Extended Elastic Impedance (RHOB, DTC, DTS Function (angle)), for example). The seismic property is extracted from the three dimensional volume at the well location and compared with the same property in the log domain (high resolution, higher sampling, higher accuracy) where the above relationships were developed.

The parameters are adjusted in these log domain relationships and applied to the same three dimensional seismic parameters, accounting for the differing resolution, sampling and accuracy between the seismic properties and the same Log domain properties.

The new adjusted relationships are then applied into the three dimensional seismic volume domain, determining all the above properties originally developed at the log domain.

FIG. 1 shows a cross-sectional view of a subterranean geological formation 100 with multiple layers of materials 101a-d that may have different physical characteristics. Data, in the form of well-log data, can be collected from one or more wells 102 drilled into or around the formation 100, including vertical or horizontal wells, for exploratory or production purposes using specially configured devices, such as a logging tool 103. The collected well-log data can include logs of the geologic formations, which are generated through core samples or borehole measurements such as gamma ray, bulk density, neutron density, induction resistivity, and/or well core or image data.

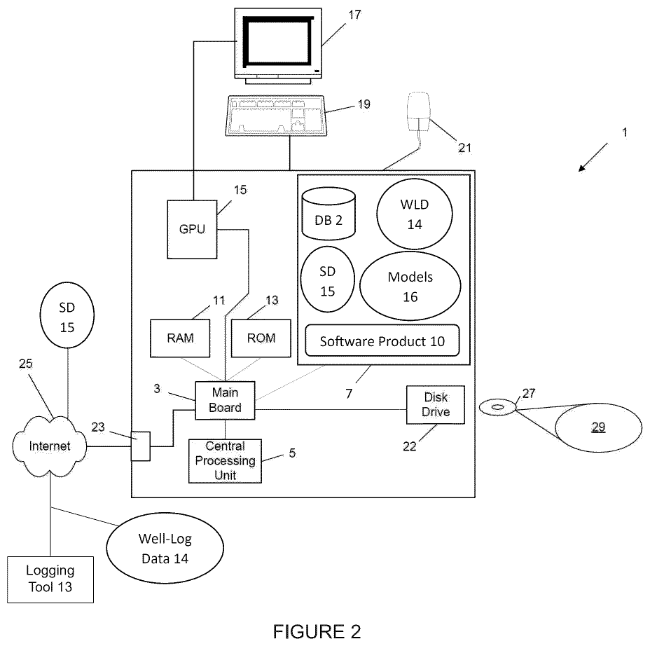

FIG. 2 comprises a block diagram of the computer system 1. The computer system 1 includes a memory in the form of a secondary storage 7, which is typically implemented by a magnetic or solid state data drive and which stores an operating system, for example Microsoft Windows, and Linux Ubuntu are two examples of such an operating system. The computer system 1 also includes random access memory 11, read only memory 13 and a graphics processing unit 15.

The secondary storage 7 also includes a software product 40 that is made up of instructions for the processor assembly 5 (which comprises processors/central processing units (CPUs)) to perform various acts according to a preferred embodiment of the present invention. The processor assembly 5, via main board 3, under control of software product 10 implements a database 2 that is also stored in the secondary storage 7, or in another data storage apparatus at another location accessible to the computer system 1, and which contains well-log data 14, seismic data 15 and three dimensional models of seismic volumes 16. The well-log data 14 and seismic data 15 may also be obtained from remote sources, such as directly from a logging tool 13, or other remote database accessible by the computer system 1.

During operation of the computer system 1 the processor assembly 5, which is typically comprised of one or more processing cores or discrete processors, loads the operating system and then loads the software 10. The software 10 may be provided in the form of tangible, non-transient, machine readable instructions 29 which are borne by a machine readable media such as a magnetic or optical disk 27 that is received in a disk drive 22.

In use the computer system 1 is operated by an administrator who is able to log into the computer system interface remotely across a network, illustrated by the Internet 25, via a networking interface device 23. The computer system 1 may also be operated using a GUI on a monitor 17 and input devices, such as a keyboard 19 and mouse 21.

It will be realized that computer system 1 is simply one example of a computing environment for executing software 10. Other suitable environments are also possible, for example the software 10 could be executed on a virtual machine in a cloud computing environment.

In some examples, the well-log data can be received or accessed from one or more memories, storage devices, and/or sensors or field devices, such as the logging tool 13 to generate well-log data. In some examples, the well-log data can include data relating to one or more of gamma ray well log(s), bulk density well log(s), neutron density well log(s), resistivity well log(s), sonic log(s), core and/or well image data, nuclear magnetic resonance log(s), spontaneous potential, deep, medium and shallow resistivity, neutron, compressional sonic, shear sonic and photoelectric effect, and/or any other well log that can be measured in the well.

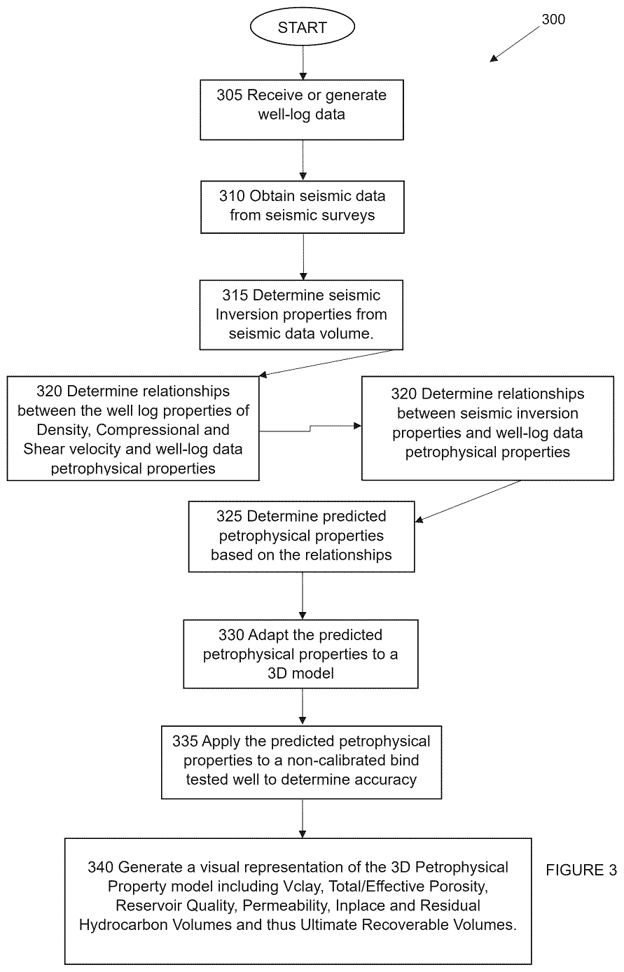

FIG. 3 shows a flowchart illustrating aspects of an example method 300 for predicting petrophysical properties from three dimensional seismic volumes.

Initially, at box 305, one or more processor(s) and/or other aspects of devices and computer system 1 may be configured to receive or generate well-log data 14 from data collected from at least one well 100 in the subterranean formation 100.

At box 310, one or more processors receive or generate seismic data 15 from data obtained from seismic surveys or seismic traces (seismograms) conducted in relation to the seismic volume.

At box 315, one or more processors determines three dimensional seismic inversion property volumes from the seismic data 15.

The three dimensional seismic inversion property volumes may be determined by applying seismic inversion to the seismic data 15. Embodiments of the invention are particularly useful applied to low resolution seismic data.

The three dimensional seismic inversion property volumes is determined from known methods of seismic inversion, such as pre-stack and post-stack simultaneous Inversion, full waveform inversion, AVO analysis, band limited inversion, coloured inversion, spectral decomposition etc, using the seismic band-limited or full-band trace data.

The three dimensional seismic inversion property volumes allow for subsurface properties (such as properties of rocks and fluids that the seismic waves passed through in the survey or trace) to be inferred from the seismic data 15.

As a result, a three-dimensional volume of estimated acoustic impedance values, which can be visualized and analyzed to identify potential reservoirs or other subsurface structures of interest, is obtained.

The three dimensional seismic inversion property volumes may include seismic attributes including one or more of Acoustic Impedance (AI), Elastic Impedance at specific angles (EI), Extended Elastic Impedance (EEI), Compressional Velocity Shear Velocity Ratio (VPVS), Density (DENS/RHOB), and Lambda-Rho. In some embodiments, these seismic attributes can be determined using the below formulae.

$$RHOB = Density ( g / cc ) , DTC = Compressional Transit Time ( us / f ) ,$$

$$DTS = Shear Transit Time ( us / f )$$

$$VP = 304800 / DTC ( m / s )$$

$$VS = 304800 / DTS ( m / s )$$

$$K = {( VS / VP )}^{⋀} 2 ( v / v )$$

$$AI = RHOB * VP ( Units = m / s * g / cc )$$

$$EI\_CON ( 18 ) = {VP}^{⋀} ( 1 + {sin}^{⋀} 2 ( deg ) ) * {RHOB}^{⋀} ( 1 - 4 K {sin}^{⋀} 2 ( deg ) ) * {VS}^{⋀} ( - 8 K {sin}^{⋀} 2 ( deg ) ( Units = m / s * g / cc )$$

$$EI\_WHIT ( 18 ) = VPO * RHOBO * {( VP / VPO )}^{⋀} ( 1 + {tan}^{⋀} 2 ( deg ) ) * {( RHOB / RHOBO )}^{⋀} ( 1 - 4 K {sin}^{⋀} 2 ( deg ) ) * {( VS / VSO )}^{⋀} ( - 8 K {sin}^{⋀} 2 ( deg ) ( Units = m / s * g / cc )$$

It will be understood that VPO, RHOBO, VSO are normalising constants.

The above seismic attributes are explained in greater detail below.

Acoustic Impedance (AI): Acoustic impedance is the product of seismic velocity and density. It provides information about the resistance of subsurface rocks to the passage of seismic waves. AI is a fundamental attribute used in seismic interpretation and reservoir characterization.

Elastic Impedance at specific angles (EI): Elastic impedance is a variation of acoustic impedance that takes into account the angle of incidence of seismic waves. It provides additional information about subsurface properties at specific angles of incidence, which can be useful for analyzing the anisotropic behavior of rocks.

Extended Elastic Impedance (EEI): Extended elastic impedance is an extension of elastic impedance that incorporates additional information, such as frequency content or other seismic attributes, to improve the characterization of subsurface properties.

Compressional Velocity Shear Velocity Ratio (VPVS): VPVS is the ratio of compressional velocity (P-wave velocity) to shear velocity (S-wave velocity). It is used to differentiate between different rock types and estimate fluid content in reservoirs.

Density (DENS/RHOB): Density, often represented by the acronym DENS or RHOB, is a measure of the mass per unit volume of subsurface rocks. It is a critical parameter for estimating seismic impedance and characterizing lithology and fluid content.

Lambda-Rho (Ap): Lambda-Rho is a seismic attribute derived from the reflection coefficient of seismic waves at an interface between two layers with different acoustic impedances. It provides information about the contrast in elastic properties between adjacent rock layers.

At box 320, the one or more processors determine relationships between the three dimensional seismic inversion property volumes and well-log data. These relationships may be mathematical relationships.

These relationships may be determined from seismic attributes of the three dimensional seismic inversion property volumes and corresponding seismic attributes of the well-log data. These seismic attributes include one or more of Acoustic Impedance (AI), Elastic Impedance at specific angles (EI), Extended Elastic Impedance (EEI), Compressional Velocity Shear Velocity Ratio (VPVS), Density (DENS/RHOB), and Lambda-Rho, as set out above and elsewhere.

More specifically, the one or more processors may determine relationships between the the well log properties of Density, Compressional and Shear velocity and well-log data.

At box 325, the one or more processors determine predicted petrophysical properties based on the relationships between the three dimensional seismic inversion property volumes and well-log data 15.

The predicted the petrophysical properties include one or more of volume of clay/shale, reservoir quality, total and effective porosity, permeability, total and effective water saturation initially in-place and residual water saturation.

More preferably, the petrophysical properties include each of volume of clay, porosity, permeability and water saturation.

The above petrophysical properties can be determined using the following formulae.

$$PHIT = APH * AI + BPH * EI\_CON ( deg ) + CPH * EI\_WHIT ( deg ) ( Units = v / v )$$

$$APH , BPH , CPH are constants$$

$$VCLAY = AC * AI + BC * EI\_CON ( deg ) + CC * EI\_WHIT ( deg ) ( Units = v / v )$$

$$AC , BC , CC are constants$$

$$VSILT = AS * AI + BS * EI\_CON ( deg ) + CS * EI\_WHIT ( deg ) ( Units = v / v )$$

$$AS , BS , CS are constants$$

It will be understood that similar relationships are developed for VP/VS Ratio, LambdaRho and MuRho.

$$PERM = 0.125 * ( {rg}^{⋀} 2 * {PHIT}^{⋀} 2 ) / ( {10}^{⋀} aVCLAY ) ; rg = typical grain radius ,$$

$$m = cementation constant , a scale constants$$

$$SWCAPT = {( ( 0.217 * height * grad * kphi ) / ( a * ift ) )}^{⋀} ( - 1 / b ) ;$$

$$height = height above FWL ( Free Water Level ) in metres$$

$$grad = water - gas fluid density or water - oil fluid density$$

$$ift = interfacial tension cosine gas = 45 , cosine oil = 25$$

$$kphi = PERM * PHIT$$

$$a , b are constants$$

In some embodiments, determining the relationships at boxes 320 and 325 does not include log averages or data relating to log averages. That is, the well-log data does not include log averages and/or does not include determining relationships based on the log averages, even if present in the well-log data.

More specifically, or in addition to the above, the mathematical relationships may be determined from the wireline log/LWD Oil/Gas exploration well or wells for the same properties determined in the seismic inversion above (i.e., AI, EI, EEI, VPVS, DENS Lambda-Rho, etc) to predict the petrophysical properties of volume of clay/shale, reservoir quality, total and effective porosity, permeability, total and effective water saturation initially in-place and residual water saturation. This can be achieved in the same way that these properties have been determined using the standard “super-combo” well log data of gamma ray, spontaneous potential, deep, medium and shallow resistivity, density, neutron, compressional sonic, shear sonic, photoelectric effect and calibrate these prediction to core data including the volume of clay, porosity, permeability and water saturation as is typically processed in well log petrophysical analysis.

At box 330, the one or more processors adapt the predicted petrophysical properties to a three dimensional static and/or dynamic model based on the seismic impedance volume.

In some embodiments, the predicted petrophysical properties are adapted to a three dimensional static and/or dynamic model based on seismic attributes of the seismic impedance volume.

More particularly, adapting the petrophysical properties to the three dimensional static and/or dynamic model based on the three dimensional seismic inversion property volumes may include adapting the petrophysical properties from seismic attributes of the well-log data to corresponding seismic attributes in a two-way time domain or depth domain using a conversion function and based on a seismic resolution of the well-log data or seismic data and sampling of the seismic data in three dimensions.

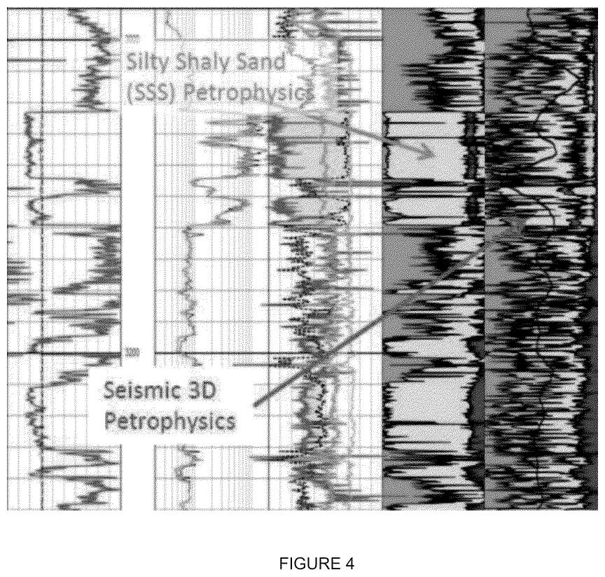

In some embodiments, the static and/or dynamic model resolution has been increased to 0.5 m from the seismic resolution of typically 2-5 m (see FIG. 4). This is achieved by calibrating to the higher resolution log data which is typically 0.5 feet. Improving the resolution of low sampled data can be achieved using techniques described in Kantaatmadja, et. Al, 2015, Society of Petroleum Engineers, Thinly Bedded Reservoir Study, Application of Sand-Slit-Clay (SSC)-SHARP-Thomas Stieber Juhasz Models, in a Deep Water Field Offshore Sabah, Malaysia, SPE-176302-MS.

FIG. 4 illustrates calibration at a field showing the standard Petrophysical evaluation from the Silty Shaly Sand (SSS) model at 0.5 ft resolution and also the property prediction from the Seismic three dimensional trace at the well location at 0.5 m resolution.

At box 335, the one or more processors apply the predicted petrophysical properties to a non-calibrated well data for blind testing and determining accuracy of the predicted petrophysical properties within the three dimensional static and/or dynamic model.

The Inventor has found that the process requires at least one well-log data set to calibrate and determine the above relationships which are then applied across the field to each sampled seismic trace/impedance property. In this way the extent of the hydrocarbon field and the variability of the field's properties can be determined without cognitive or conceptual biasing. The predictions can then be used to blind test against any existing well or any exploration well yet to be drilled. Blind testing provides a true measurement of the accuracy and uncertainty of the model property prediction.

In some embodiments, the method includes determining in-place and/or residual hydrocarbon volumes in the seismic volume of the model. These in-place and residual hydrocarbon volumes in the seismic volume represent an estimate of the total amount of hydrocarbon material in the reservoir (the in-place hydrocarbon volume) and an estimate of the residual amount of hydrocarbon material in the reservoir after production has taken place.

At box 340, the one or more processors generate a visual representation of the three dimensional static and/or dynamic model. (see FIG. 5).

Outputs of embodiments of the method and system described herein can be seen in FIGS. 5-10.

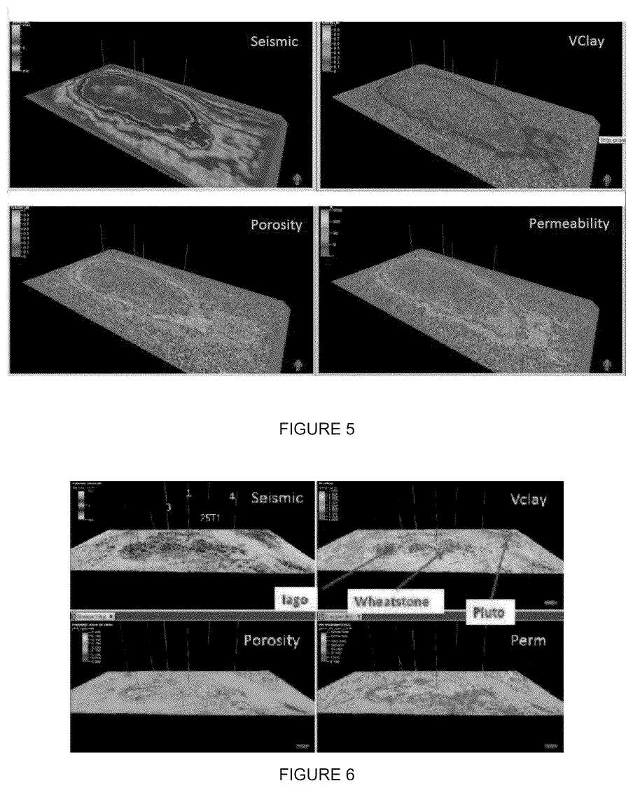

FIG. 6 illustrates three dimensional Property modelling as follows (clockwise from top left): a) top left display shows the input Seismic band-limited trace data, b) top right the Petrophysical volume of clay results, c) bottom left displays the porosity and d) bottom right displays the variation in permeability and thus changes in reservoir quality across the Wheatstone field. The three dimensional properties for the nearby lago and Pluto fields can also be identified.

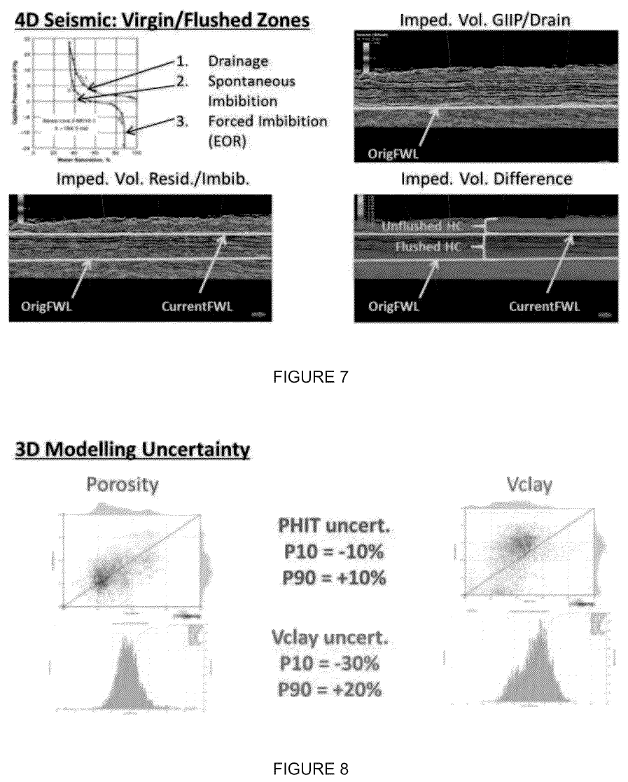

FIG. 7 illustrates four dimensional (including time) property modelling as follows (clockwise from top left): a) top left displays the typical drainage and imbibition capillary pressure curves b) top right displays the in place impedance volumes with original free water levels c) bottom left displays the simulated current free water level and the resulting flushed impedance property and d) bottom right displays the difference between the in place and flushed impedance properties, highlighting where hydrocarbons have been produced and yet to be produced.

FIG. 8 illustrates that three dimensional property modelling uncertainty can be determined by cross plotting against the measured log data properties.

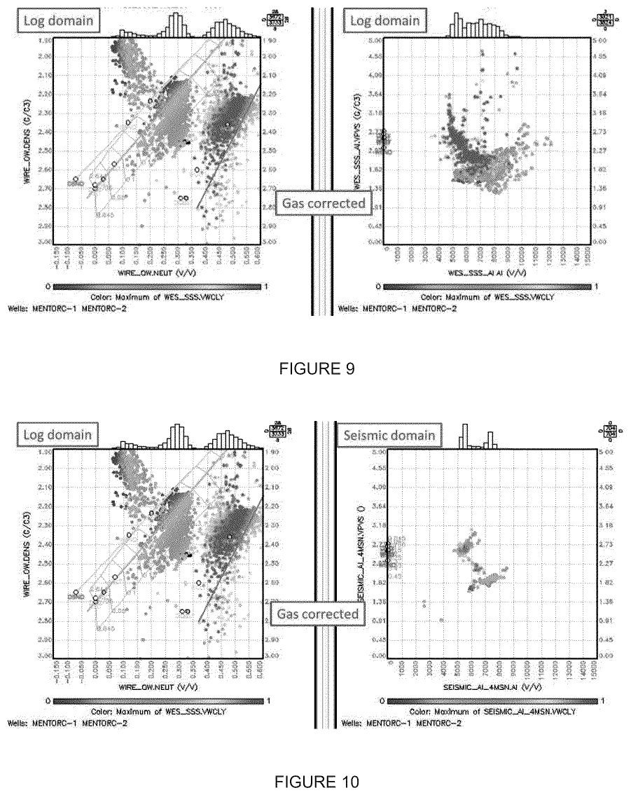

FIG. 9 is a graphical representation of the density and neutron porosity measurements obtained from well logging. The plot is a scatter plot of the two porosity measurements, with density porosity on the x-axis and neutron porosity on the y-axis. The Density-Neutron cross-plot is used in petrophysical analysis to distinguish between different lithologies and fluid types based on their response to the density and neutron porosity measurements.

FIG. 10 is a graphical representation of the acoustic impedance (AI) and the ratio of compressional velocity (VP) to shear velocity (VS) obtained from seismic data in both the log domain (left) and the seismic domain (right).

The plots are scatter plots of the two seismic attributes, with AI on the x-axis and VP/VS on the y-axis.

The AI-VPVS cross-plot is used in geophysics to distinguish between different lithologies and fluids based on their response to the seismic data.

Determination of the in-place hydrocarbon volumes is the first step to understand and developing a reservoir. Predicting where the hydrocarbons will flow and calibrating this against four dimensional (including time) Seismic data, helps identify where hydrocarbons have been produced, known as flushed zones and also where hydrocarbons have yet to be produced known as virgin hydrocarbon intervals. With the ability to predict the variation is reservoir quality, the embodiments of the methods and systems described herein are also able to determine the areas where hydrocarbon will flow and how much residual saturation will remain. By using drainage and imbibition capillary pressure and saturation height functions, the in place and residual saturation can be determined.

The embodiments described herein are implemented by physical computer hardware, including computing devices, servers, receivers, transmitters, processors, memory, displays, and networks. The embodiments described herein provide useful physical machines and particularly configured computer hardware arrangements.

The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

### RESULTS AND ADVANTAGES

Embodiments of the methods and system described herein for three dimensional property prediction is faster (at 2-4 weeks rather than typically 3 months or more for statistical approaches and 6 months or more for geological conceptual models) and more accurate than current industry methods.

Embodiments of the invention provide for improved signal resolution of a lower sampling signal.

The property predictions are not infected by cognitive or conceptual biasing. The property predictions are calculated and constrained to the three dimensional Seismic trace (survey)/impedance volume, thus removing any cognitive or conceptual biasing. The use of science, physics and mathematical relationships is more accurate than conceptual/statistical models based upon averages.

In addition, embodiments of the invention develop the relationships to the well log data and validates the predictions by blind testing against existing known data and applies the prediction algorithms into the three dimensional space, honouring the three dimensional sampling resolution used in the blind test predictions.

Furthermore, the use of drainage and imbibition saturation height functions enables flushed and virgin hydrocarbons to be identified, significantly aiding in targeting low water cut hydrocarbon production volumes.

Validated and accurate three dimensional property predictions can provide significant reduction in appraisal well drilling requirements.

Additionally the significant reduction in time taken (requiring only 1-2 months) to determine and populate these properties into the three dimensional space, significantly increase the net present value of the asset over the more traditional conceptual modelling approaches which often takes at least 2-5 years.

Further to the above, embodiments of the invention provide improved accuracy and processing speed while also providing predictions on initially in-place hydrocarbon volumes, ultimate recoverable volumes, recovery factors and areas of best and worst reservoir/property values.

Embodiments of the invention do not rely on or favour “up-scaling” in any direction. Instead, embodiments of the invention use the three dimensional model sampling and is independent of direction and therefore unbiased. In effect, embodiments of the invention have no preconceived idea of what the property prediction will be.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

Program code may be applied to input data to perform the functions described herein and to generate output information. The output information may be applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof. In some examples, devices having at least one processor may be configured to execute software instructions stored on a computer readable tangible, non-transitory medium.

1. A method of predicting hydrocarbon reservoir properties in a three dimensional model of a seismic volume, the method includes:
determining three dimensional seismic inversion property volumes from seismic data;
determining relationships between seismic attributes of the three dimensional seismic inversion property volumes and well-log data, wherein the seismic attributes of the three dimensional seismic inversion property volumes are associated with one or more wells and the well-log data are associated with the one or more wells, wherein determining relationships between the three dimensional seismic inversion property volumes and well-log data does not include log averages or log average data or probabilities of properties based upon log average data;
determining predicted petrophysical properties based on the relationships between the three dimensional seismic inversion property volumes and well-log data, wherein determining predicted petrophysical properties based on the relationships between the three dimensional seismic inversion property volumes and well-log data does not include log averages or log average data or probabilities of properties based upon log average data;
adapting the predicted petrophysical properties to a three dimensional static and/or dynamic model based on the seismic attributes of the three dimensional seismic inversion property volume; and
adapting the petrophysical properties from seismic attributes of the well-log data to the corresponding seismic attributes of the three dimensional seismic inversion property volumes in a two-way time domain or depth domain based on a seismic resolution of the well-log data or seismic data and sampling of the seismic data in three dimensions.

2. The method according to claim 1, wherein the three dimensional seismic inversion property volumes are determined by applying seismic inversion to the seismic data.

3. The method according to claim 1, wherein the method further includes generating a visual representation of the three dimensional static and/or dynamic model.

4. The method according to claim 1, wherein the seismic attributes of the three dimensional seismic inversion property volumes include one or more of Acoustic Impedance (AI), Elastic Impedance at specific angles (EI), Extended Elastic Impedance (EEI), Compressional Velocity Shear Velocity Ratio (VPVS), Density (DENS/RHOB), Lambda-Rho and Mu-Rho.

5. The method according to claim 1, wherein the well-log data includes data relating to one or more of gamma ray, spontaneous potential, deep, medium and shallow resistivity, density, neutron, compressional sonic, shear sonic and photoelectric effect.

6. The method according to claim 1, wherein the petrophysical properties include one or more of volume of clay/shale, reservoir quality, total and effective porosity, permeability, total and effective water saturation initially in-place and residual water saturation.

7. The method according to claim 6, wherein the petrophysical properties include one or more of volume of clay, porosity, permeability and water saturation.

8. The method according to claim 1, wherein the method further includes receiving or generating seismic data from data obtained from seismic surveys or seismic traces (seismograms) conducted in relation to the seismic volume.

9. The method according to claim 1, wherein the method includes applying the predicted petrophysical properties to a non-calibrated well data and determining accuracy of the predicted petrophysical properties within the three dimensional static and/or dynamic model.

10. The method according to claim 1, wherein determining relationships between the three dimensional seismic inversion property volumes and well-log data includes determining relationships between the seismic attributes of the three dimensional seismic inversion property volumes and the corresponding seismic attributes of the well-log data.

11. The method according to claim 1, wherein the method further includes determining in-place and/or residual hydrocarbon volumes in the seismic volume from the model.

12. The method according to claim 4, wherein:
$$RHOB = Density ( g / cc ) , DTC = Compressional Transit Time ( us / f ) ,$$
$$DTS = Shear Transit Time ( us / f ) ;$$
$$VP = Compressional Velocity ( 304800 / DTC ) ( m / s ) ;$$
$$VS = Shear Velocity ( 304800 / DTS ) ( m / s ) ;$$
$$K = Compressional / Shear Velocity Ratio {( VS / VP )}^{⋀} 2 ( v / v ) ;$$
$$AI = Acoustic Impedance ( RHOB * VP ) ( Units = m / s * g / cc ) ;$$
$$Connelly Elastic Impedance EI\_CON ( deg ) = {VP}^{⋀} ( 1 + {sin}^{⋀} 2 ( deg ) ) * RHOB \hat{} ( 1 - 4 K {sin}^{⋀} 2 ( deg ) ) * {VS}^{⋀} ( - 8 K {sin}^{⋀} 2 ( deg ) ( Units = m / s * g / cc ) ;$$
$$Whitcombe Elastic Impedance EI\_WHIT ( deg ) = VPO * RHOBO * {( VP / VPO )}^{⋀} ( 1 + {tan}^{⋀} 2 ( deg ) ) * {( RHOB / RHOBO )}^{⋀} ( 1 - 4 K {sin}^{⋀} 2 ( deg ) ) * {( VS / VSO )}^{⋀} ( - 8 K {sin}^{⋀} 2 ( deg ) ( Units = m / s * g / cc ) ,$$
$$wherein VPO , RHOBO , VSO are normalising constants .$$

13. The method according to claim 4, wherein:
$$PHIT = APH * AI + BPH * EI\_CON ( deg ) + CPH * EI\_WHIT ( deg ) ( Units = v / v ) , APH , BPH , CPH are constants ;$$
$$VCLAY = AC * AI + BC * EI\_CON ( deg ) + CC * EI\_WHIT ( deg ) ( Units = v / v ) , AC , BC , CC are constants ;$$
$$VSILT = AS * AI + BS * EI\_CON ( deg ) + CS * EI\_WHIT ( deg ) ( Units = v / v ) , AS , BS , CS are constants ;$$
$$PERM = 0.125 * ( {rg}^{⋀} 2 * {PHIT}^{⋀} 2 ) / ( {10}^{⋀} aVCLAY ) ; rg = typical grain radius ,$$
$$m = cementation constant , a scale constants ;$$
$$SWCAPT = {( ( 0.217 * height * grad * kphi ) / ( a * ift ) )}^{⋀} ( - 1 / b ) ,$$
$$height = height above FWL ( Free Water Level ) in metres ,$$
$$grad = water - gas fluid density or water - oil fluid density ,$$
$$ift = interfacial tension , cosine gas = 45 ,$$
$$cosine oil = 25 , kphi = PERM * PHIT , a , b are constants .$$

14. A system for predicting hydrocarbon reservoir properties in a three dimensional model of a seismic volume, the system comprising:
a memory storing instructions for one or more procedures; and
a processing assembly configured to execute the one or more procedures stored in the memory;
wherein the one or more procedures, when executed by the processing assembly cause acts to be performed including:
determining three dimensional seismic inversion property volumes from seismic data;
determining relationships between seismic attributes of the three dimensional seismic inversion property volumes and well-log data, wherein the seismic attributes of the three dimensional seismic inversion property volumes are associated with one or more wells and the well-log data are associated with the one or more wells, wherein determining relationships between the three dimensional seismic inversion property volumes and well-log data does not include log averages or log average data or probabilities of properties based upon log average data;
determining predicted petrophysical properties of the seismic volume based on the relationships between the three dimensional seismic inversion property volumes and well-log data, wherein determining predicted petrophysical properties based on the relationships between the three dimensional seismic inversion property volumes and well-log data does not include log averages or log average data or probabilities of properties based upon log average data;
adapting the predicted petrophysical properties to a three dimensional static and/or dynamic model based on the seismic attributes of the three dimensional seismic inversion property volume; and
adapting the petrophysical properties from seismic attributes of the well-log data to the corresponding seismic attributes of the three dimensional seismic inversion property volumes in a two-way time domain or depth domain and based on a seismic resolution of the well-log data or seismic data and sampling of the seismic data in three dimensions.

15.-18. (canceled)
